(19) United States
(12) Patent Application Publication
(10) Pub. No.: US 2014/0245141 A1
(43) Pub. Date: Aug. 28, 2014

(54) CONTEXTUAL USER ASSISTANCE FOR CLOUD SERVICES

(71) Applicant: MICROSOFT CORPORATION, Redmond, WA (US)

(72) Inventors: Erh-Chun Yeh, Newcastle, WA (US); Serena Daly, Kirkland, WA (US); Matthew Tyler Josiah Rasmussen, Maple Valley, WA (US)

(73) Assignee: Microsoft Corporation, Redmond, WA (US)

(21) Appl. No.: 13/777,947

(22) Filed: Feb. 26, 2013

(51) Int. Cl. G06F 3/0481

(52) U.S. Cl. CPC G06F 3/0481
USPC 715/708

(57) ABSTRACT

To provide contextual user assistance for cloud services, an assistance panel is presented as part of the cloud service portal and is available in the user interface of the portal. The assistance panel can provide contextual assistance based on current user information, including task or error messages, as well as product name and user role. The assistance panel provides assistance functions including a search function, a browse syndicated community content function, and a post to a community forum function within the cloud service portal and can transform to accommodate the functions. For the browse function, the assistance panel uses the current user information to dynamically update a list of syndicated community content that can potentially match the user's needs as the user navigates to different pages presented in the portal. A content curator tool can be used to control and prioritize the content surfaced by the browse function.

### BACKGROUND

While working within a product such as a software application running on a computer system, a user may experience difficulty in completing a task and desire assistance. Currently, a user may have to interrupt their task to search for a solution from a number of channels. In general, a user typically first looks for assistance in-product. However, unless there is a Help tool in the user interface for the product, a user leaves the page or window in which the task is being performed to search a Help source or contact an expert, such as someone working in an IT department or a paid consultant.

Many organizations, both small and large, and individuals currently engage in the support and upkeep of their computer systems and the products running on those systems. However, a shifting paradigm is emerging where resources and services are hosted by an outside party (or parties) and presented as a cloud service. To assist with migrating to cloud services from using a staffed IT department or paid consultant(s), there is a need for self-support experiences for users to obtain the assistance they may need.

### BRIEF SUMMARY

In-product user interfaces and techniques for contextual user assistance for cloud services are described.

To provide a steady state embedded experience for users to obtain additional assistance from within a cloud service product experience, an assistance panel is presented with a product's user interface on a portal (e.g., via browser application). The panel can provide contextual assistance based on current user information, including task or error messages, as well as product name and user role.

The assistance panel uses the current user information to dynamically update a list of syndicated Help content that can potentially match the user's needs as the user navigates to different pages presented in the portal. The Help content can be obtained from various sources including websites, a Support knowledge base, community forums, and product support resources. A search field can also be provided to enable users to search Help content by keywords and receive curated content further scoped by the user's product, role and current task. The assistance panel also provides a gateway for users to compose a question from the portal, submit the question directly to a community forum, and receive a notification when the question is answered—without leaving the portal.

Authoritative content made available to the user through the assistance panel can be curated using a specialized qualifier for tags in order to promote the authoritative content for surfacing in the assistance panel. The specialized qualifier can be applied by administrators using a community management dashboard—that allows an administrator to attach a tag having the qualifier to content the administrator deems authoritative. The content having the qualifier attached to tags (e.g., private tags) can be surfaced in the assistance panel.

The assistance panel interface includes behaviors to mitigate disruption to the user experience while facilitating interaction with the assistance panel.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a diagram of an operating environment in which certain embodiments may be carried out.

FIG. 2 shows an example interface with assistance panel that may be implemented.

FIG. 3 shows an illustrative architecture for an embodiment of the invention.

FIG. 4 shows an example user interface with assistance panel carrying out a video chat function according to an embodiment of the invention.

FIG. 5 shows a process flow for a search scenario according to an embodiment.

FIG. 6 illustrates auto suggestion for an action (task) link that is relevant to what the user types.

FIG. 7 shows a process flow for a browse scenario according to an embodiment.

FIG. 8 shows a process flow diagram for a post scenario according to an embodiment.

FIGS. 9A-9C show a floating model for the user interface and assistance panel according to an embodiment of the invention.

FIGS. 10A-10C show a search function expansion model for the assistance panel according to an embodiment of the invention

FIGS. 11A and 11B show a post function expansion model for the assistance panel according to an embodiment of the invention.

FIGS. 12A-12C show illustrative user interfaces of a content curator tool.

FIG. 13 shows a system overview of an implementation of an assistance panel according to an embodiment of the invention.

FIG. 14 shows a block diagram illustrating components of a computing device used in some embodiments.

### DETAILED DESCRIPTION

In-product user interfaces and techniques for contextual user assistance for cloud services are described. Embodiments provide a more enhanced context-sensitive assistance (“help”) for users of a cloud service. Certain embodiments provide a user interface configured to minimize work flow disruption that can occur in cases where a user leaves a software application or task to get help from another source.

Some reasons for a user to get help from another source include a desire to learn or obtain additional information, a desire to optimize or explore different features, as well as break/fix scenarios. A “break/fix” scenario refers to a case where there is a failure of technology in the normal course of its function and there is a need for some support organization (or person) to restore the technology to working order.

Often, a customer first looks to get help and solve problems themselves. For example, a user may perform self-help by searching channels including Help articles created specifically for the software application, blogs, and wikis.

Where self-help does not solve the problem, a user may move to community assisted channels such as forums or other interactive sites. In the community assisted forums, a user may be able to ask and obtain an answer to their questions. Sometimes the community assisted channels do not provide an answer to a post or do not provide an answer within a desired time-frame. In those cases, a user may move to agent assisted channels. Agent assistance is typically performed online or by phone. Sometimes an issue is escalated to a product team.

Certain embodiments use information about who a user is (e.g., their role), what services have been provisioned for the user, and where the user is in the process of their task to get help for the user within the product experience.

FIG. 1 shows a diagram of an operating environment in which certain embodiments may be carried out.

Referring to FIG. 1, the operating environment can include one or more cloud or web services such as software services 100.

A cloud service generally refers to hosted services providing scalable processing and storage capabilities. Cloud computing may often include virtualized resources. The resources presented by cloud computing are in themselves provided as a service, where cloud computing customers rent usage of resources from a third-party provider that owns the physical infrastructure. A client organization that is served by a cloud service and shares resources controlled or managed by the cloud service with other client organizations can be referred to as a tenant.

Web services can be provided and/or hosted by a cloud service (e.g., as part of a large-scale distributed computing environment). A web service is a software system that supports interoperable machine-to-machine interaction over a network and enables software to connect to other software applications.

A web service provides a collection of technological standards and protocols. For example, a web service provides functions that may be implemented by a software or hardware agent that sends and receives messages (e.g., the computing platforms requesting and providing a particular service). Applications can access web services via ubiquitous web protocols and data formats such as hypertext transfer protocol (HTTP), XML, JavaScript Object Notation (JSON), and SOAP (originally an acronym for simple object access protocol).

Representational state transfer (REST) protocols are useful when accessing named resources and may be used in certain embodiments of the invention. In other embodiments of the invention SOAP may be utilized. In some cases, a File Synchronization Service via SOAP over HTTP (FSSHTTP) from Microsoft Corp. may be used.

The software services 100 may be associated with broader cloud services 105 as well as a web application component (WAC) 110. WACs are components that enable a user of a client device 115 to view and edit documents in a browser application 120 via a user interface 125 rendered on a display 130 of the client device 115. In such embodiments, users have access to application software and databases on the cloud, which manages infrastructures and platforms. The user may access the cloud service through entering a uniform resource locator (URL) in the browser application 120.

The client device 115 can involve computing systems configured with one or more central processing units (CPUs), memory, mass storage, and I/O devices (e.g., network interface, user input device). Elements of a computing system can communicate with each other via a bus. In certain embodiments, the client device 115 can be embodied as a computing device including, but not limited to, a personal computer, a tablet, a reader, a mobile device, a personal digital assistant (PDA), a smartphone, a laptop (or notebook or netbook) computer, a gaming device or console, a desktop computer, or a smart television.

The client device 115 is configured to execute an operating system and one or more application programs such as, in the illustrated embodiment, a browser application 120 and/or one or more other applications.

An operating system is a computer program for controlling the operation of the client device 115. The application programs are executable programs configured to execute on top of the operating system to provide various functionality.

The browser application 120 is an application program for retrieving and traversing information resources on the World Wide Web (“the Web”), as well as resources provided by web servers in private networks, and presenting the information resources to a user (e.g., rendering for display). Moreover, the browser application 120 allows a user to access information and various functions provided by a server or servers (such as the software services 100).

In addition, or as an alternative, to accessing software applications hosted on the cloud through a browser (e.g., browser application 120), some client devices 115 may access the software applications hosted on the cloud through an app (an application designed for mobile devices such as smartphones and tablets).

The user interface 125 through the browser application 120 (or app) becomes a portal to software application(s) and other resources available through the cloud service(s). A portal refers to an entry point to content and which may deliver application server content and functionality. The portal may be a web portal that brings information together from various sources and presents an aggregate of content from other systems or servers.

The cloud or web services, including software services 100 (and other cloud services 105) may be implemented using one or more physical and/or virtual servers communicating over a network. The network can include, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

When using a cloud service, there may be very little data stored on the client device 115. Instead, data is stored on the infrastructure, “the cloud,” (e.g., in a data store 135), and this data can be leveraged to improve user experience. By providing services in the cloud, various elements about a user, such as user 140 is known. These elements can include what role the user has, what page the user is viewing, what page the user left from, and in some cases, what page other people similar to the user came from or will be going to.

A user role refers to the grouping of privileges allocated to a particular person. A privilege refers to a right granted by the system to access a system record or execute a particular task.

According to embodiments of the invention, the product(s) hosted by the cloud service for a particular tenant and the role a particular user is assigned are known and used to provide assistance, in conjunction with context concerning the task or page the user is on. Because the content in the portal to the cloud service is controlled by the cloud, information stored on the server (whether in cache or persistent storage), for example in data store 135, can be accessed and used to provide built-in assistance as described herein.

To provide a steady state embedded experience for users to obtain assistance in-product, an assistance panel is presented on a portal (e.g., via browser application 120).

Assistance panels as described herein may be incorporated into cloud or web services including those providing online productivity and service software such as email, calendars, web conferencing, website managing, and editors (e.g., for document creation and editing).

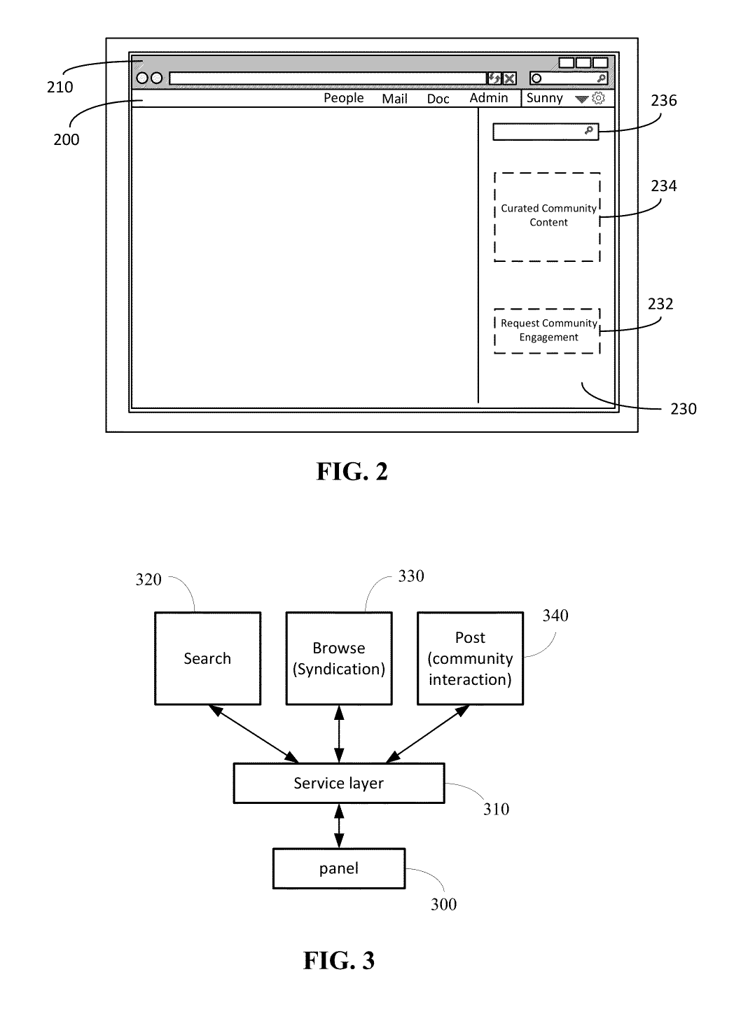

FIG. 2 shows an example interface with assistance panel that may be implemented. Referring to FIG. 2, a user can access a portal to a cloud based product 200 through a browser 210 on a client device 220. An assistance panel 230 can be rendered within the portal for the product 200 as part of the user interface.

For example, if a user is in the process of setting up a feature through a wizard tool but would like to have help, the user does not have to leave the wizard (go off line, search, find the information, and go back to determine how the information relates to what the user wants to do). By presenting an assistance panel 230 on the same page and window as the tool, a user can work within the tool, ask for help, receive the help, and return to working within the tool all in the same place.

As part of the built-in assistance product experience, community engagement 232 can be incorporated with the assistance panel 230. The community engagement may begin in response to a user selecting to request community engagement 232, and both the request and the interaction with the community (e.g., a post or chat) can be carried out from within the assistance panel 230.

Community engagement includes the interactive aspects of a community forum or other comment and post platform. The porting of community content from a community forum into the product (via the assistance panel 230) can reduce the occasions for a user to go outside the product to a community and find something that might be relevant.

Community content refers to user generated content and is generally not predefined. Rather, community content is curated according to topics the community deem of interest or relevant.

Not only is the community content being provided in-product, embodiments use context to obtain and surface community content that is expected to have some relevancy for the user and what task the user is performing. This curated community content 234 may be dynamically surfaced on the assistance panel 230 as the user works within the product 200. In some embodiments, other content can be surfaced as part of the curated community content 234.

According to embodiments, the assistance panel can present assistance that is contextual and relevant, augmented, and integrated with a community.

The assistance can be contextual in that the information presented to the user is relevant to the user state and the service/product state (such as the location where a help request is invoked or the state explicitly selected). Both user defined parameters (e.g., parameters based on user and state) and explicitly collected parameters, such as through a search tool 236 available on the assistance panel 230, can be used to scope assistance results obtained from internal, community, and broader web-based content sources.

Users of the assistance panel can discover and consume various types of assistance content and engage with community support on a separate, yet within, window experience, for example as illustrated in FIG. 2.

FIG. 3 shows a diagram of a system architecture for an assistance panel. Referring to FIG. 3, an assistance panel 300 can be used to provide in-product assistance to a user. A service layer 310 for the panel 300 is provided for in-situ search (which may be presented as search tool 236), curated content syndication or “Browse” (which may be presented as curated community content 234), and posting features (which may include a request for community engagement 232). According to an embodiment, a search function 320, browse function 330 and post function 340 are available within the assistance panel 300 through use of the service layer 310.

Embodiments of the panel advantageously facilitate a minimal disruption to a user's work-flow while presenting an in-situ help experience. Certain embodiments advantageously enable an escalating investment of assistance resources such that a user may first perform self-help measures before engaging with others to find a solution.

The search function 320 for in-situ search experience provides a search tool that enables users to search across channel sources with a single scoped search entry point.

The browse function 330 provides an integrated help (e.g., content authored for the software application) and community content that is scoped using context to present curated content of “popular answers.” It should be understood that the use of the term “popular” does not necessarily designate a highest rated or most viewed content; rather, the popular answers provide a highest probable match to solving a potential issue that a user may have with respect to a task, improving the user's experience with a particular task, highlighting a new tool, or even providing insight as to what the community is discussing related to a particular task or issue.

According to embodiments of the invention, the popular answers links are dynamically updated based on context of user and product state and what task the user is performing. The curated content feed can be based on editorial board input across multiple sources.

The post function 340 provides integrated community engagement through enabling a post to a community forum.

Other functions for assistance may also be provided as part of the assistance panel. For example, a text chat, video chat, or audio chat function may also be available.

In one embodiment, a chat function can be included and implemented similarly to the post function in order to provide human engagement within the panel 300 and product portal.

In another embodiment, human engagement may be carried out through an embedded video and/or audio conferencing capability. For example, video chatting may be available that can be accessed by a button that surfaces if a user has not been able to find a solution through the search, browse, or post options.

In some embodiments, both chat and video may be available.

In one case, a collaboration service such as MICROSOFT LYNC, a registered trademark of Microsoft Corp., may be embedded in the panel that can connect the user to a community support person such as a MICROSOFT “Most Valuable Professional” (MVP) so that the user may have a conversation from within the panel.

According to certain embodiments, the ability to video chat (and/or text chat) is presented in a manner that is not disruptive. In addition, because the panel knows that there is a problem (through context information), the panel can pro-actively search out for an expert on the problem. For example, if a user is in a domain administration task when asking a question (similar to or as an extension of the post function), the panel knows to look for a domain expert from available contacts because of the domain administrative task source context.

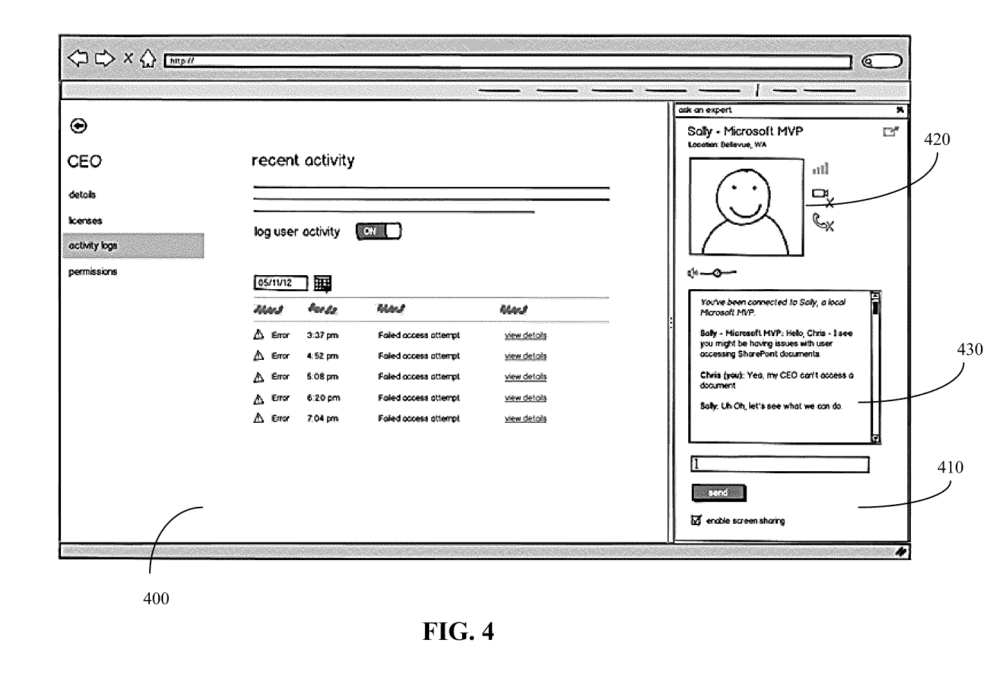

FIG. 4 shows an example user interface with assistance panel carrying out a video chat function according to an embodiment of the invention. In response to the context of, for example, an error message in an activity log, the assistance panel may present an option to speak with an expert. If the user selects to speak with the expert while within the product portal 400, the assistance panel 410 can bring up video 420 and, in some cases, a message or chat box 430—all in-context.

To implement the search (320), browse (330), and post (340) functions (as well as any other assisting function), the service layer 310 of the assistance panel 300 identifies the context and incorporates the context in invoking a service related to retrieving community content and/or filtering results.

Parameters used to identify context include, but are not limited to, one or more of the following: stock-keeping unit (SKU), product version (e.g., professional, enterprise), role (e.g., administrator, information worker), task (e.g., page and field level details), locale identifier (geographical region and/or language), Server (datacenter), client operating system, browser, and feature version.

In many embodiments, at a minimum, SKU, role, and task parameters are used by the assistance panel.

As used herein, SKU refers to an identifier related to the products and/or services hosted by a cloud service for a particular tenant. For example, for the cloud-based service MICROSOFT OFFICE365, a registered trademark of Microsoft Corp., a tenant may have a subscription to one or more products available from Microsoft Corp. such as MICROSOFT EXCHANGE and MICROSOFT SHAREPOINT, registered trademarks of Microsoft Corp. A tenant's SKU information would indicate the product being used (or available to the user). The SKU can include information as to the version of the product. In some cases, the SKU can indicate the type of user (individual, small business, enterprise) or purchase point of the product.

An administrator is a designated individual (or individuals) responsible for maintaining a multi-user computing system. The administrator is often involved in assigning and handling resources and privileges for other users.

An information worker (IW) refers to a person who may be involved in one of three information and technology usage categories. One subset of IW is the knowledge worker, typically middle/senior managers, consultants, and marketing executives. The knowledge worker typically creates, consumes, modifies, and analyzes data to develop and improve processes.

Another, common subset of IW, is the structured task worker. Examples include bank clerks and managers, hospital/nurse supervisors, and shop managers. The structured task worker tends to work with data and information by creating and consuming information. Their needs tend to focus on fast access to information and the ability to create documents and modify information. The third subset is the data entry worker, who creates and consumes data, typically in the form of standardized processes and forms. The data entry worker is often someone in an administrative, secretarial or receptionist role.

The task parameter includes information related to what a user is doing and the user's location on a page. For example, a user having the role of administrator may be setting up domains, managing other users, and assigning rights to those other users.

In addition to SKU, user role, and other context described above, embodiments can use information related to life cycle of the services (for example, whether set-up is complete and the product is being used), whether the users are actually using all the services they are entitled to, historical information as to a user's past actions and/or error history or reported issues, and even information about other tenants and their actions and/or issues.

The context parameters are used in a variety of ways by the assistance panel depending on the particular assistance being presented.

In an example implementation, context of particular scope (“scoped context”) is facilitated through scoped context public tags assigned to the context of the user's experience. The scoped context public tags may be established for a variety of tasks and states and may be allocated by the product or the service hosting the product. Example scoped context public tags that may be used (as a task parameter) include, but are not limited to, Manage Users, Manage Contacts, Manage Mailboxes, Delete Users, Reset Password, Add User, Edit User, Edit Contact, and Edit Distribution group. It should be understood that this list is not exhaustive and that more or fewer than the example scoped context public tags may be used. In addition, because scoped context public tags may reflect the particular product being used, each product may have relevant tags that can be assigned to particular tasks and states.

In a specific embodiment, Help articles (and community information) can include keyword tags. These tags may include a consistent string that is applied to Help topics based on what product, version, and user role the Help topic applies. There may be a public tag string representing the context. The context refers to the task or page in which the user is working. For example, when the user is in a page for resetting a password, the tag for this context may be “Reset Password.” When a search is conducted, a context string (or tag) and a string providing the product, version, and user role can be appended to the query from the user and passed to a service searching Help topics, a knowledge base or a community forum.

Search:

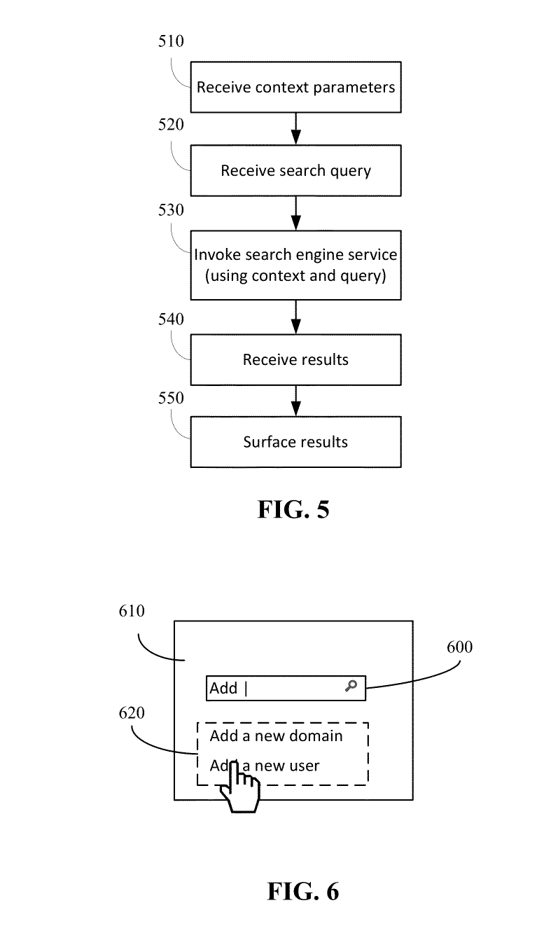

Search includes contextual parameters and the keyword(s) from user input to a search input field (also referred to as a search bar). FIG. 5 shows a process flow for a search scenario according to an embodiment. Referring to FIG. 5, contextual parameters can be received (510) and a search query can be received (520) by the panel. The search query can include keywords used to search the community resources. It should be understood that the contextual parameters and search query may be received in any order and that some keywords and parameters may be received intermittently and even simultaneously.

In some cases, the search bar that receives the search query can also include natural language processing. The natural language processing can facilitate assistance in cases where the user does not know the terminology for the question being asked.

Once the system receives an indication that the search query is complete, for example, as indicated by the user hitting “enter,” a search engine service can be invoked (530) and the contextual parameters and keywords may be passed through to the service.

In some cases, the user may select the sources being searched. In many cases the search is conducted within internal (product related) or community sources; however, a broader web-based search may be provided.

In certain embodiments, error keywords text (from the task or process being carried out on the page) can be passed as additional keywords, and even, in some cases, auto-populating the search query.

The results of the search can be received (540). The results may be filtered by the search engine service using the contextual parameters, or the filtering may be performed by the panel. Search results can include forum posts, blog posts, wiki articles, product Help topics and knowledge base articles.

The received search results can be surfaced (550). The type of content may be labeled in the result, in-line with each result set. In some embodiments, search results are filterable by content type.

Forum answered states may also be available in the results panel if the forum's post is answered. In one embodiment, to provide a link to the source, the community content types can be clickable in order to open a new browser window, taking the user to the community landing page for that particular content type.

In one search example, the BING search engine application programming interface (API) can be called. BING is a registered trademark of Microsoft Corp. In other embodiments other search engines may be called. The search engine can be used to query and filter results based on parameters passed to the search service.

For the search function, the source or task context can be passed to a search page, along with any keywords entered with the user's search query. Tags can be used to limit (or filter) the scope of the query.

The selection of results can be controlled by an administrative tag (“Admin tag”). Admin tags can be used in the search engine to scope the search results in a similar manner used with conventional tags. Specific context tags can also be used to map context to internal product Help content. In some embodiments, values for filtering are in the form of meta-name value pairs, obtained from Admin tags.

The particular query arrangement can be provided in a format suitable for the API being called. A service can be called to obtain the content for surfacing within the assistance panel. In one example, a Help article may be obtained by passing a query “password help Reset Password ProductABC admin site:[location (or URL)]” where “password help” is the user query, “Reset Password” is the context string, “ProductABC” is the product name or code (e.g., the SKU), and “admin” is the user role. A uniform resource locator (URL) can be passed to call the resource. In another example, a knowledge base may be searched by passing a query “password help Reset Password site:[location (or URL)] AND meta:Search.Products([product name or code]).” Another query arrangement may use a format of “password help site:[location (or URL)] AND meta:Search.Tag (Reset Password’) AND meta.Search.Tag (‘Admin’) AND meta.Search.Tag (ProductABC). In all cases, the context string enables the results to be scoped to context.

FIG. 6 illustrates an auto suggestion for an action (task) link that is relevant to what the user types. The auto suggestion for an action/task attempts to direct users to obtain in-portal support before they start searching from the community. When a user types, via a search bar 600 of an assistance panel 610, a search keyword starting with an action, such as “add,” a suggested list of “add” actions 620 can be displayed for user to select. This is shown in FIG. 6, where one of the suggested actions 620 may be selected. The “add” or other action keyword results can be suggested using similar contextual information as would a search or browse function as described herein. The list of add actions (or any other action results auto selection) includes Wizard/How-to content from the portal (i.e., as an internal tool of the product as opposed to community content). When a suggested action is selected, the user can be redirected to the portal Wizard/How-to page.

In some embodiments, as a user enters a search keyword or query (such as in operation 520), the syndicated content (e.g., “popular answers”) can also be updated. In these embodiments, when the user starts to input text of the search query, the popular answers get updated based on the keyword(s) that user has input as well as the contextual parameters. The updated popular answers may provide the Help the user is searching for or aid in the user finding the suitable terminology to ask for help before the user hits “enter” to use the search bar 600.

In one embodiment, even if the panel is collapsed, as the user starts to type, the panel may automatically expand and show text entered into the search bar.

Browse:

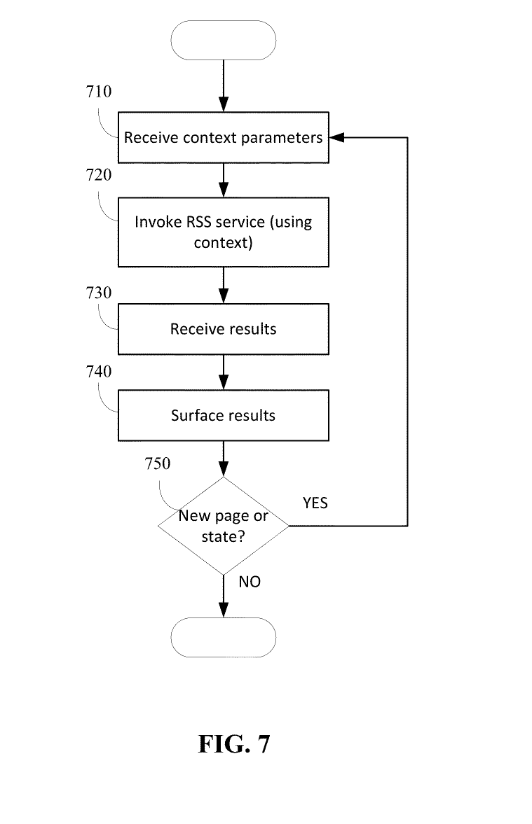

Browse involves presenting curated results as syndicated content in the assistance panel. FIG. 7 shows a process flow for a browse scenario according to an embodiment. Referring to FIG. 7, the panel can receive contextual parameters (710).

Contextual parameters used to implement the content syndication for the Browse function include, for example, user information (e.g., SKU name), the page level details where user currently is (e.g. domain, password reset), and error messages (if any). These parameters are used to scope search results by showing user, task, and/or error related topics as popular answers.

Content can be editorially selected and tagged appropriately in order for the content to surface from the panel. Popular answers can be limited to authoritative content through the use of Admin tags. In one example, an Admin tag involves incorporating the Admin qualifier to a tag such as “popularpanel” or “panel”. Where the qualifier is a “!”, the Admin tag to identify the authoritative content that is qualified for Popular Answers may be “!panel”. A tag with the qualifier may be referred to as a private tag. According to certain embodiments, content without the tag “!panel” will not be returned from the search results or, if returned, will not be surfaced on the assistance panel. Tags can be used for scoping context to community and non-community content.

The syndicated content of popular answers can include curated community content, wiki, forum, blog and internal product Help papers or other content. For forums, the forum threads with verified answers may be shown. This content may be found from searching a rich site summary (RSS) feed for Help content. The panel can invoke a RSS service (720) to receive the Help content for syndicating popular answers (730).

Popular answers can be returned from a community RSS server endpoint or a RSS feed management service, which can search the RSS. According to an embodiment, this search engine returns Authoritative items (from blogs, wikis or forums) that have been tagged with the admin tags, dictating which items show up in the panel and which items will not be considered for showing up in the panel. In one example, the admin tags can be “!panel” and “!{source}” where source is one of dozens of strings that define which area of the product the user is in. Each portal page can have a fallback “default” list of popular answers in case a search of the RSS feed returns 0.

For Browse scenarios, the portal can send a request through the RSS search URL to the community content server and get the data returned in XML file. Contextual parameters can be passed to the RSS search to get contextual syndication. The multiple tags can be comma separated. The sort order can also be passed to the URL. The data items from the RSS feed includes “Title, description”—and may include additional tags. The panel can list the returned titles from the data in the XML file as a popular answer. The portal page renders the raw data from XML file in a format that conforms to the portal site HTML and cascading style sheets (CSS) standard. In this manner, the result can be surfaced on the panel within the portal window (740).

The panel can syndicate top N relevant content that is scoped by these parameters (where N is a set number or varying number based on a number of results that can fit in the assistance panel according to display size). For example, N may be 1, 2, 3, 4, 5 or more top results. In some embodiments, a maximum of 10 results are shown. According to certain embodiments, popular answers are sorted by relevance (to the contextual parameters).

As the user navigates through different pages (750), the page level parameters are changed, resulting in updates to the popular answers.

Sometimes a community site will not have all of the popular answer topics. A wiki landing page can be created and tagged to provide these topic (hyper)links for the panel.

The popular answer user experience can provide a user with a content preview so the user can decide whether they want to read the whole article or topic prior to explicit navigation away from the portal. Preview detail may be provided. For example, with community content, the title, date of content posted, and some of the text of the content can be displayed. For some content, there may not be a preview. In some cases, the user will click to be taken to the source page in order to view the content.

In one embodiment, when a user clicks one of the popular answers, the result can open in a new tab. In another embodiment, when a user clicks one of the popular answers, the result can be displayed in the assistance panel.

For the popular answers experience, content that was curated and targeted to the particular user (scoped based on the SKU, user role, and context such as page or state) is presented on the panel when the panel is open.

The popular answers differ from search results in that the popular answers are displayed on the panel—as opposed to an extended page—and are pre-curated for the particular page the user is on and dynamically populated based on the context. That is, the popular answers feature provides a specialized search that does not require the user's input or explicit search request.

In one embodiment, the popular answers are the default elements surfaced on the assistance panel. In some embodiments, the popular answers are presented as part of the open panel at any time except for when a search is performed and/or a post is being submitted.

Post

The posting feature lets a user post into the community—and if/when someone answers the question—the user can be notified within the portal—so there is no need for the user to leave the task.

For the post scenario, when a user clicks a link for asking or posting a question (an “Ask a question” link), the create post interface is surfaced on the assistance panel. The “Ask a question” link initiates a user flow for posting a question to the community from within the task window. According to various embodiments, the process flow lets the user provide some information about their problem, and then shows the user some existing questions to see if the problem can be solved from within the program. In some embodiments, the posting feature can include a preview pane where the user is shown, while typing, some possible questions others have asked that contain some of the same words the user enters. If the existing questions do not help, then the user is able to fill in the rest of the question and submit it. If the user is a new user to the community, extra information can be obtained through the assistance panel. If the user is an existing community member, the post can be completed.

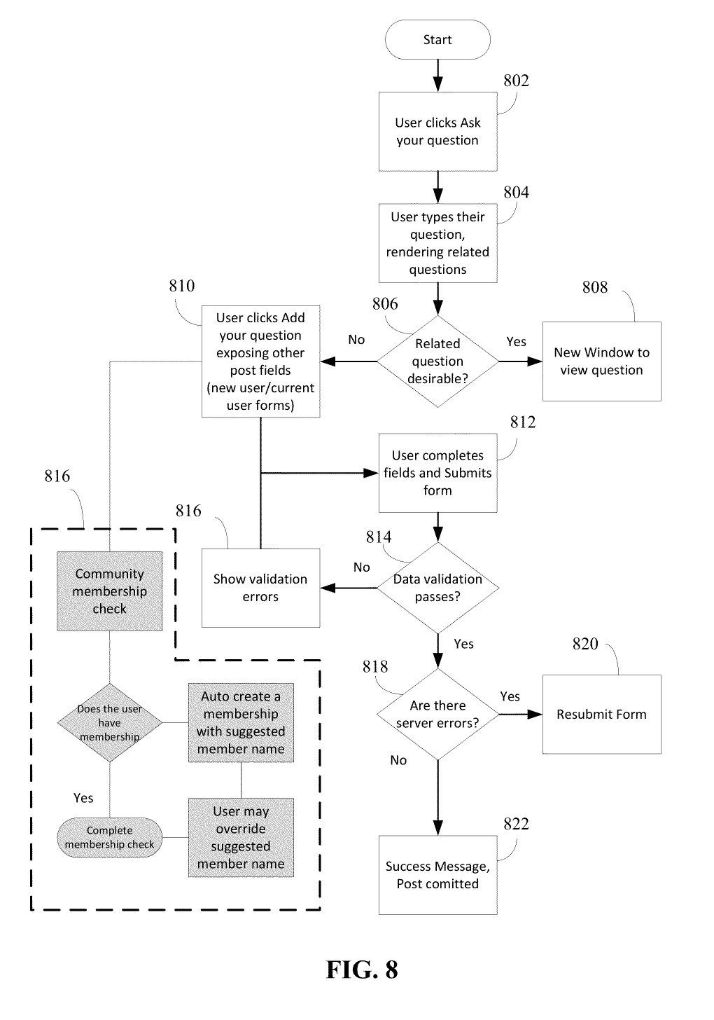

FIG. 8 shows a process flow for a post scenario according to an embodiment.

The user flow begins when the “Ask a question” link is clicked (802). At operation 804, the user is prompted to type in a question. As the user types in the question, related questions may appear in a dropdown menu. The related questions can be based on the terms or subject entered by the user. In operation 806, it can be determined whether one of the related questions is desirable by the user's response.

If the user sees a related question that may have the answer to their question, the user may select the related question. A new window can open for the user to view the question and answer from the community content (808). If the user does not see their question in the related questions list, the user can select to add their question as a new question (810).

If the user is not a community member, an additional step can be carried out within the assistance panel for the user to join the community. In one embodiment, the additional step involves having the user set their display name and email address. Operations 811 show a sub-process for checking community membership that may be carried out during a post scenario according to an embodiment. In some embodiments incorporating a community membership check, a membership can be auto created with a suggested member name. The user may override the suggested member name.

The process can be carried out entirely from within the task window in the assistance pane—even error messages.

For example, when the user completes their form (whether for new user or current member) (812), the information on the form is checked to determine whether the data is valid (814). If the data is not valid, validation errors are surfaced in the panel (816) and the user has an opportunity to correct the issues. Similarly, once it is determined that there are no validation errors, the success of posting is checked (818). If there are server errors, the form may be resubmitted (820). If there are no server errors, the post can be committed (822). The task context can be used to decide which forum category to post to so during operation 822 when the post is committed, the post may be posted to the forum category related to the task context.

The user post can be submitted to the forum the context is mapped to and the appropriate tags and Admin tags can be added to the post by the panel.

A REST API provided by the community forum platform can be used to enable posting from within the assistance panel. For post scenario, the panel (and portal) can interact with the community through a REST API provided by a community forum platform. A REST API of a community forum platform for use by the panel includes functions to check if a user has a community profile, create a user profile, and submit a post.

Upon completion of posting to the community forum, the user is returned to the original assistance panel with a confirmation message and a link to view the questions they have previously posted. The link can take the user to their community activities (and which may open a new window).

According to embodiments, the assistance panel is configured to transform in ways to facilitate the assistance functions.

Certain embodiments are directed to the behavior of the assistance panel.

For example, panel screen expansion can be instantiated to accommodate in-window interaction with the assistance panel. The panel can stay open; it can also be dismissed. According to embodiments, the panel can be configured to surface different Help aids based on different data being fed to the panel from the back end hosted in the cloud.

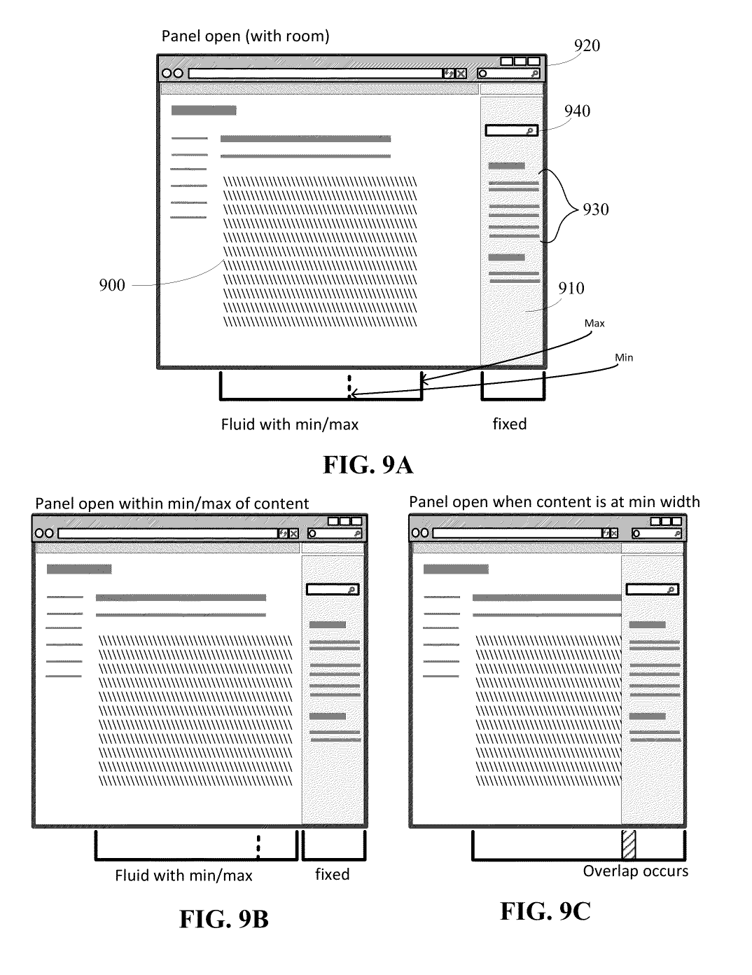

FIGS. 9A-9C show a floating model for the user interface and assistance panel according to an embodiment of the invention. The user interface with canvas 900 and assistance panel 910 can be rendered within a browser 920. As used herein, a “canvas” refers to the main region of a product interface where the user interacts and views content.

If a minimum/maximum (min/max) size of the canvas 900 is defined, the panel 910 will open within an appropriate region of the fluid sized canvas 900. The panel 910 can float above the canvas 900 when the canvas reaches the defined minimum size. The panel height may be dynamic based on browser height and may assume the height of a portal page.

When the browser 920 is resized such as shown in FIGS. 9B and 9C, the primary content on the page (e.g., canvas 900) can collapse to a point, which may be defined by the minimum size, and eventually no longer collapse. At that point, the panel 910 begins to float above the content as shown in FIG. 9C. The size of the panel itself does not necessarily change.

In some cases, the panel 910 can be collapsed (not shown) to maximize canvas area when the user is not interacting with the panel 910. A collapsed panel may be automatically called if an error occurs as part of a task being conducted in the product interface. In some cases, an action by the user can call the panel, for example, by selecting an expander indicator on or near the collapsed panel or by typing or entering an input that may appear to be a search query (where the typing or other input is not being directly performed with respect to an input field or region on the canvas). The panel can be called and collapsed; however, according to certain embodiments, the panel is not dismissed or hidden.

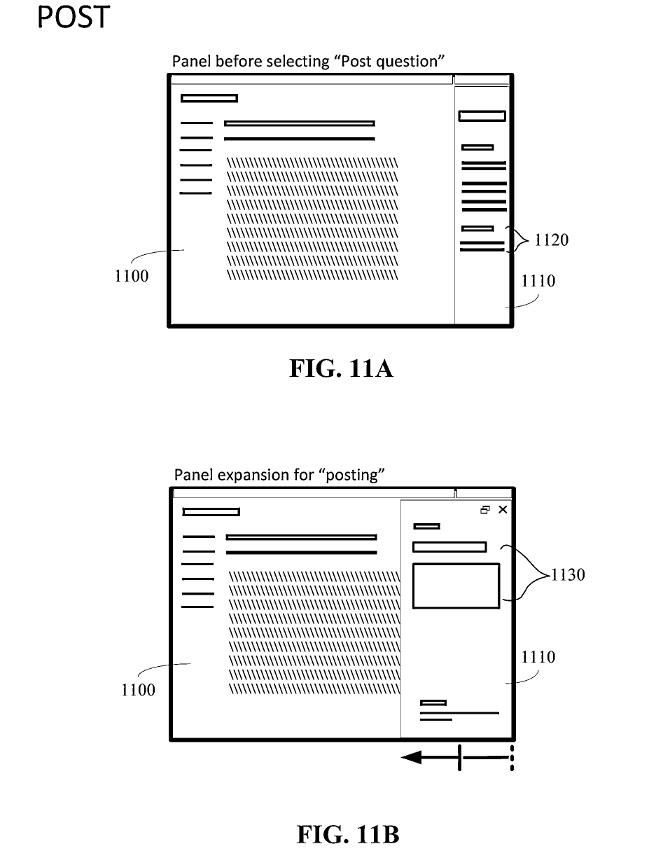

The panel may be a fixed width size, but can widen to a second size when in certain modes, such as when a post function is being carried out as described with respect to FIGS. 11A and 11B.

While a user is working within the canvas 900, the browse functionality can be implemented by the panel 910. For example, the assistance panel 910 may present the curated content 930 during the time that a user is interacting with the canvas 900 to perform a particular task.

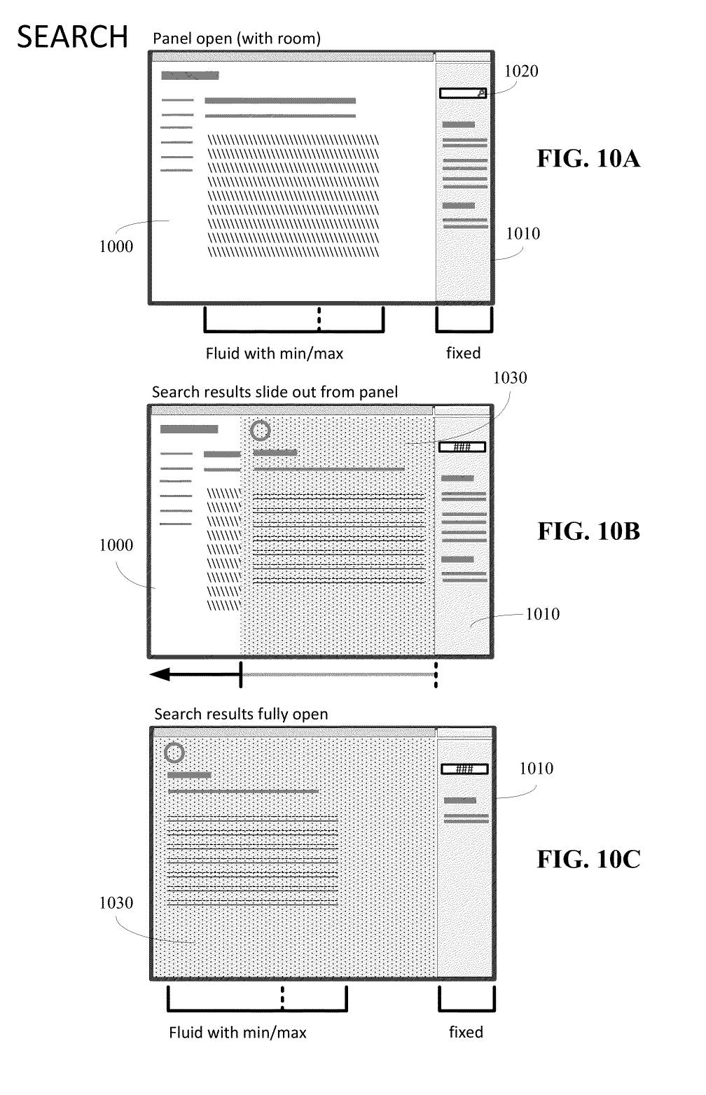

To facilitate a search experience, which can be available when the panel is open, a user can enter a search term in a search field 940. The results of the search can be presented in-situ. One example is illustrated in FIGS. 10A-10C.

FIGS. 10A-10C show a search function expansion model for the assistance panel according to an embodiment of the invention. Referring to FIG. 10A, the user interface with canvas 1000 and assistance panel 1010 can operate as described with respect to FIGS. 9A-9C. For the search experience, a user can enter a phrase or terms into a search field 1020. When a user presses the enter key following an explicit “search” within the assistance panel 1010, a search results pane 1030 opens within the portal user interface (and may slide out from the assistance panel 1010 to cover the canvas 500 as shown in FIGS. 10B and 10C). The search results pane may extend from the side panel (like a sheet) over the task the user is performing.

The search results pane 1030 can be closed so that the user can see the canvas 1000 on which the user was performing the task. When dismissing the results pane 1030, the results pane 1030 can slide back to the assistance panel 1010 and disappear.

Search results can be viewed from within the search results pane 1030. A click of a link may open a new page or stay within the current page.

According to an embodiment, a first interaction or “click” returns results in-situ, and a next click (to an in-situ result) can open a new window to source. The search results may be rendered in a manner consistent with the view from a search page result view—to provide a user with an expected experience, as well as the functionality for click-throughs. Clicking the link in the results pane 1030, may redirect the user to the source site in a new browser window. Clicking a content back button that is present in search result pane 1030 restores the assistance panel to original pre-search state.

FIGS. 11A and 11B show a post function expansion model for the assistance panel according to an embodiment of the invention. The user interface with canvas 1100 and assistance panel 1110 can operate as described with respect to FIGS. 9A-9C. As shown in FIGS. 11A and 11B, when a user selects to post a question (for example, via an option to post 1120 presented on the assistance panel 1110), the assistance panel 1110 expands to accommodate entering a post (such as through posting field 1130). The panel 1110 can adjust in size to accommodate the posting action while enabling the posting to be accomplished within the context of the panel so the user does not have to leave the task. Many embodiments even enable a user to create an account from within the assistance panel 1110.

Although the assistance panel is shown and described as being positioned at the right side of a window, embodiments are not limited thereto. The assistance panel may be positioned at the left side, bottom side, or top side in other implementations.

Although “clicking” actions are described herein, it should be understood that other actions can be used in any of the described embodiments to provide a similar result. These other actions include voice indications (such as a verbal input of “select link”) and touch or gesture indications (such as a tap, a certain swipe or motion).

A content curator tool is provided to speed up the ability to make Help content available to users. The tool enables content delivery to be more targeted by giving publishers and editors control of how certain content can be found and given prominence to a user requesting assistance. The content curator tool enables a content curator to manage what kind of content will be shown to what type of users. The panel can access the content curated using the content curator tool and decide what subset of content is going to be shown to the user based on the contextual information regarding who the user is, what the user is doing, and what program/product the user has. Some of the curated content is used for pre-populating dynamic popular answers that are surfaced on the panel.

A community server administrator panel for the content curator tool may include a content type called “Popular Answers” (to represent the syndicated authoritative content for the panel). Users of a given administrator role to “manage popular answers” may access a control panel widget to go in and maintain these popular answers. Such administrators can view a list of all the popular answers in a paged list; view a list of all the popular answers for a given context source, task and locale; create a new popular answer and tag the new popular answer with the appropriate source or task context; and edit an existing popular answer, save the changes and refresh the Title attribute in the existing supported locales.

Mapping contextual parameters for community content can be performed against public tags. For the curated content, a search of authoritative content that matches the contextual parameters is conducted. The product, version, and user role information can be incorporated as tags for certain content such that the appropriate content can be surfaced.

Designated administrators may create private tags that begin with a qualifier indicator (e.g., starting with “!”) in a tag input box. Because the control panel checks for administrative rights, If a non-administrator user enters a tag starting with “!”, the Exclamation marks can be removed from tags. Admin tags may be kept invisible to other (non-administrator) users throughout the community site.

The Admin tag can be used by administrators to control the priority and quality of the content that is surfaced. The Admin tag also provides protections so that when content is tagged as valuable for surfacing, the tag and/or content is not changed by the general public.

The Admin tags can be used by the panel in search engine requests to scope the search results in a similar manner as other tags.

Instead of modifying the queries to surface the appropriate content, embodiments provide a private tag that facilitates the surfacing of appropriate content for a user's question. The modification to the metadata of a community post, a topical paper, an expert's contact information, a video or other content can be accomplished through the content curator tool. The modified metadata (by the Admin tag qualifier) improves the results being surfaced so that incorrect, incomplete, or merely passable answers can be avoided.

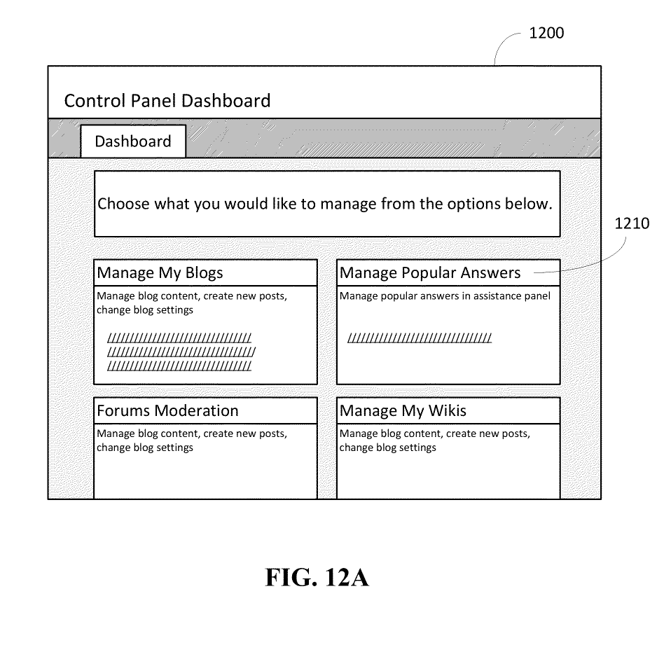

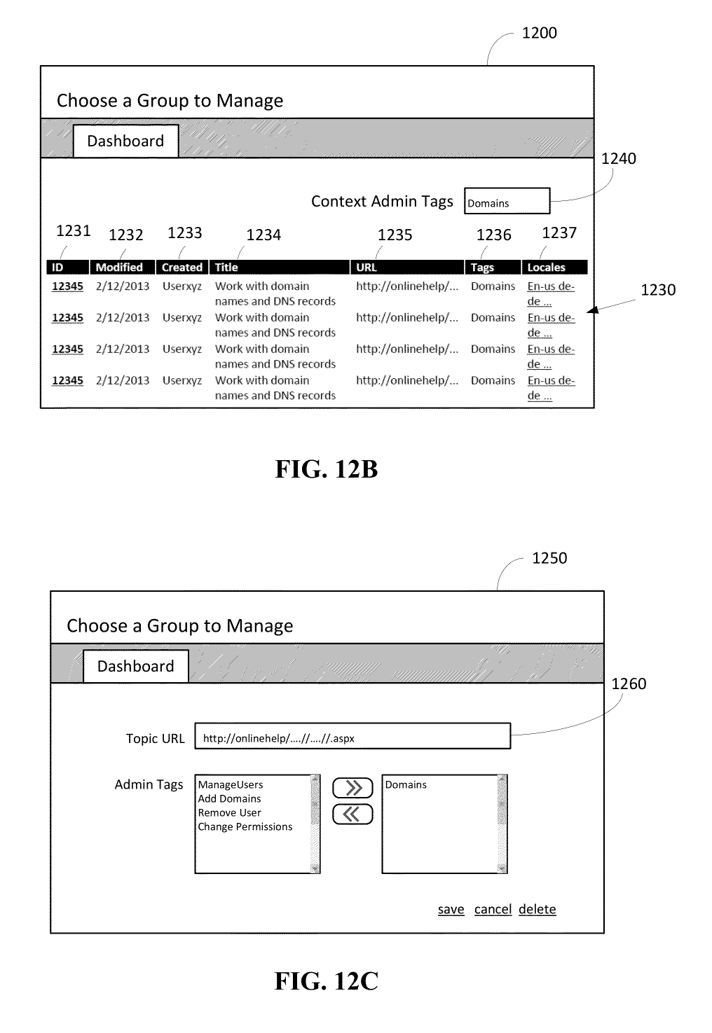

FIGS. 12A-12C show illustrative user interfaces of a content curator tool.

FIG. 12A shows a control panel dashboard 1200. The manage popular answers access 1210 in the control panel dashboard 1200 is exposed to users who have a “manage popular answers” role. A user can access the Manage Popular Answers page such as shown in FIG. 12B by selecting the item access 1210 through the control panel dashboard 1200.

FIG. 12B shows a control panel page 1220 with the RSS feed for a popular topic having an admin tag for domains. A popular answer line 1230 may include information such as an identifier (1231), date saved (1232), user who added the popular answer (1233), title of the topic (which can be presented as a link to edit the topic) (1234), the URL (1235), the list of tags (1236) and a link to the locales the topic exists for (1237). The locales 1237 (and link) provides a list of all the locales and URL the topic includes. A search RSS can be provided in the control panel. For the control panel search, popular answer topics are included in queries for !Panel and !SourceContext admin tags, along with Blog, Wiki and Forum results for use within the content curator tool.

FIG. 12C shows a page 1250 to view popular answer topics (identified by Topic URL 1260) to edit/add Admin tags.

As an illustrative example, a person having management rights can ensure that certain articles show up in the assistance panel for a particular context. For example, given a Help article for a particular product that is geared towards an administrator managing users for that product, the person can ensure that the article shows up in the assistance panel when a user is in the Manage Users area of the product through using a control panel dashboard 1200. After selecting the “Manage Popular Answers” access 1210, the control panel page 1220 opens and the person can see a list of popular answers by source or task context tag. The person can select “!Manage Users” in the menu 1240 and sees a list of topics, the one that the person wants to add is not there so the clicks add (not shown). This takes the person to a page such as shown in FIG. 12C that asks for the URL and the admin tags that the person wants to apply to the new Help article. The person can select !Manage Users and click save. After a moment, the person may be returned to the list of popular answers and the title and URL of the newly added article can be found.

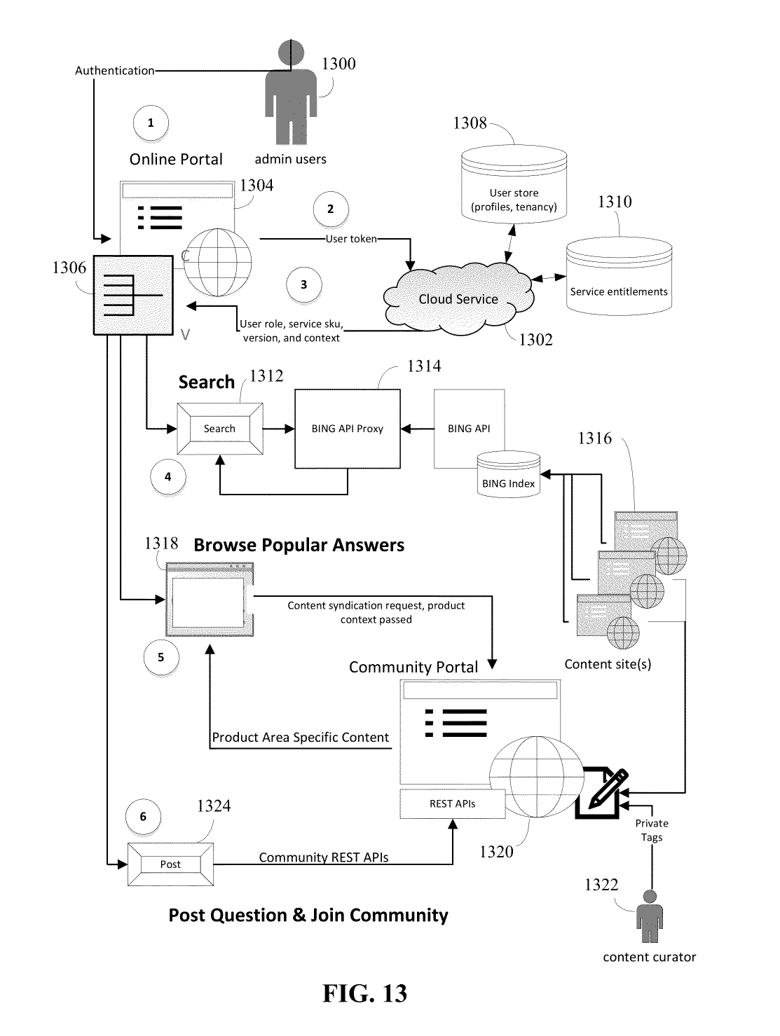

FIG. 13 shows a system overview of an implementation of an assistance panel according to an embodiment of the invention.

Referring to FIG. 13, an admin user 1300 for a company is authenticated in order to access cloud services 1302 through an online portal 1304 configured with an assistance panel 1306 in accordance with an embodiment of the invention. The authentication process includes the user 1300 providing authenticating information, such as a log-in identifier, to the online portal 1304, which then sends a user token to the cloud services in order to establish access to the cloud services. The cloud services 1302 uses the user token to determine, from the User store 1308 and Service entitlements 1310, the services (domains and number of seats) that are provided to the admin user 1300. The cloud services provides information concerning user role, service sku, version, and context to the assistance panel 1306 based on the interactions the admin user 1300 has with the products being accessed through the online portal.

The search function 1312 from the assistance panel 1306 can be carried out when the user types a keyword. The system can assume user sku, version, role, and product area to send a scoped query. The user query and the scope query can be sent to a search engine API 1314 (and may use the BING API and BING API Proxy) that may then obtain content from multiple sites 1316. The results of the query involve scoped search results, including content supported by the company producing the product as well as community resources.

The browse function 1318 can involve a community portal 1320 to which a content syndication request and product context is passed. Content from the content sites 1316 may be accessed by the community portal 1320 after a content curator 1322 enters a subset of the content from the content sites for syndication and applies private tags to specify product area. The community portal 1320 can then provide product area specific content from the curated content.

The post function 1324 can call Community REST APIs—that may be accessible via the community portal 1320. The post function can obtain automated user community enrollment and automated tagging of the post with version, sku, and role. The REST API Methods that may be called include community health, get user profile, get user question status, create user profile, set authentication (rps (relying party suite) information), and post question.

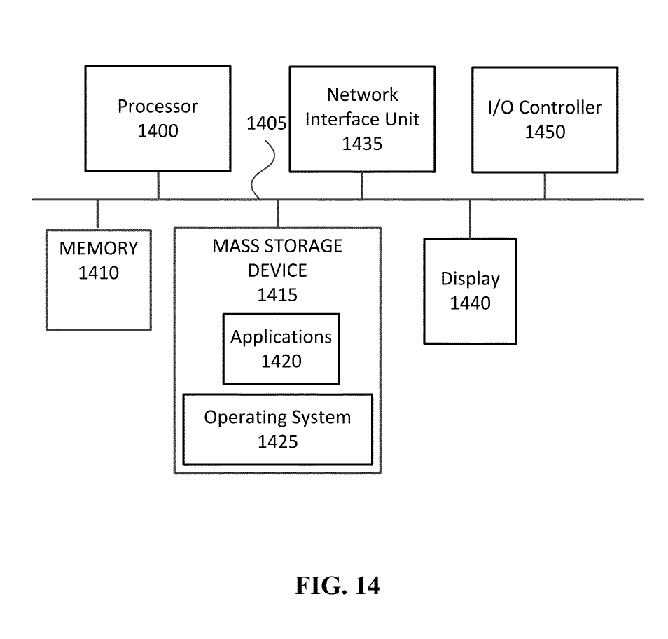

FIG. 14 shows a block diagram illustrating components of a computing device used in some embodiments. It should be understood that aspects of the system described herein are applicable to both mobile and traditional desktop computers, as well as server computers and other computer systems. For example, touchscreen or touch-enabled devices (included, but not limited to touch-enabled track pad or mouse) may be applicable to both mobile and desktop devices.

Referring to FIG. 14, a computing device can include a processor 1400 connected to components via a system bus 1405; a system memory 1410 and a mass storage device 1415. The processor 1400 processes data according to instructions of one or more application programs 1420, and/or operating system 1425. The processor 1400 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and network connectivity components (e.g., including network interface 1435).

The one or more application programs 1420 may be loaded into the mass storage device 1415 and run on or in association with the operating system 1425. Examples of application programs include phone dialer programs, e-mail programs, PIM programs, word processing programs, spreadsheet programs, Internet browser programs, messaging programs, game programs, and the like. Other application programs may be loaded into the mass storage device 1415 and run on the device, including various client and server applications.

It can be understood that the mass storage device 1415 may involve one or more memory components including integrated and removable memory components and that one or more of the memory components can store an operating system. According to various embodiments, the operating system includes, but is not limited to, SYMBIAN OS from Symbian Ltd., WINDOWS MOBILE OS from Microsoft Corporation, WINDOWS PHONE OS from Microsoft Corporation, WINDOWS from Microsoft Corporation, PALM WEBOS from Hewlett-Packard Company, BLACKBERRY OS from Research In Motion Limited, APPLE IOS from Apple Inc., and GOOGLE ANDROID OS from Google Inc. Other operating systems are contemplated.

The system memory 1410 may include a random access memory (“RAM”) and/or a read-only memory (“ROM”). The RAM generally provides a local storage and/or cache during processor operations and the ROM generally stores the basic routines that help to transfer information between elements within the computer architecture such as during startup.

A synchronization application may also be included and reside as part of the application programs 1420 for interacting with a corresponding synchronization application on a host computer system (such as a server) to keep the information stored in a non-volatile storage (such as of mass storage device 1415) synchronized with corresponding information stored at the host computer system.

The network interface 1435 allows the system to communicate with other computing devices, including server computing devices and other client devices, over a network. The network interface 1435 can include a unit to perform the function of transmitting and receiving radio frequency communications to facilitate wireless connectivity between the system and the “outside world,” via a communications carrier or service provider. Transmissions to and from the network interface 1435 are conducted under control of the operating system 1425, which disseminates communications received by the network interface 1435 to application programs 1420 and vice versa.

Visual output can be provided via a display 1440. The display may be a touch screen display. A touchscreen (which may be associated with the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

In other embodiments, a touch pad may be incorporated on a surface of the computing device that does not include the display. For example, the computing device may have a touchscreen incorporated on top of the display and a touch pad on a surface opposite the display.

The computer architecture also may include an input/output controller 1450 for receiving and processing input from a number of other devices, including a keyboard, mouse, electronic stylus, or microphone. Similarly, the input/output controller 1450 may provide output to a display screen (such as display 1440, a printer, speakers, or other type of output device).

In some embodiments, the display and the keypad are combined. In some embodiments two or more input/output (I/O) components including an audio interface and a video interface may be combined. Discrete processors may be included with the I/O components or processing functionality may be built-in to the processor 1400.

It should be understood that any mobile or desktop computing device implementing system described with respect to FIG. 14 may have more or fewer features or functionality than described and is not limited to the configurations described herein.

For example, in some embodiments, user interfaces and information of various types may be displayed and interacted with on a wall surface onto which user interfaces and information of various types are projected.

In various implementations, data/information stored via the system may include data caches stored locally on the device or the data may be stored on any number of storage media that may be accessed by the device via the network interface 1435 or via a wired connection between the device and a separate computing device associated with the device, for example, a server computer in a distributed computing network, such as the Internet. As should be appreciated such data/information may be accessed through the device via the network interface 1435 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Computer-readable instructions, data structures, program modules, or other data can be embodied as a modulated data signal in, for example, a wireless medium such as a carrier wave or similar mechanism such as employed as part of a spread spectrum technique. The term “modulated data signal” refers to a signal that has one or more of its characteristics changed or set in a manner as to encode information in the signal. The modulation may be analog, digital or a mixed modulation technique. Communication media, particularly carrier waves and other propagating signals that may contain data usable by a computer system, are not included as computer-readable storage media.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A computer-implemented method of providing contextual user assistance for cloud services, comprising:
determining context comprising user role information, service product information, and task information for a user accessing a service product through an online portal;
providing an assistance panel within a user interface of the online portal, the assistance panel surfacing curated help content according to the user role information, the service product information, and the task information,
wherein the curated help content is updated as the context changes.

2. The method according to claim 1, wherein the curated help content comprises content originating from at least one of a community forum, blog, and wiki, and having a private tag associated therewith.

3. The method according to claim 1, further comprising:
receiving a user search query to the assistance panel;
requesting help content from a search service using the user search query and a scope query created from the user role information, the service product information and the task information; and
receiving help content results for surfacing in the assistance panel.

4. The method according to claim 3, wherein the assistance panel transforms to extend a search results pane over the user interface of the online portal for surfacing the help content results.

5. The method according to claim 3, further comprising:
identifying one or more keywords from the user search query and passing the one or more keywords to a community portal providing the curated help content; and
updating the curated help content on the assistance panel before requesting the help content from the search service.

6. The method according to claim 1, further comprising:
receiving a request for community engagement to the assistance panel; and
providing a portal to a community forum or video chat in the assistance panel.

7. The method according to claim 1, further comprising:
receiving a request for community engagement to the assistance panel;
transforming the assistance panel to provide a post interface;
posting a question received from the post interface in the assistance panel to a community forum.

8. The method according to claim 7, wherein the post interface comprises a new user form in response to a determination that the user is not a member of the community forum.

9. The method according to claim 1, wherein the task information comprises one or more tags indicating user action, user location on a page of the online portal, or error state.

10. A user interface for contextual user assistance, comprising:
an assistance panel in an online portal of a service product;
wherein the assistance panel has a first state of being collapsed to maximize an area of the online portal interface, a second state of being in standard expansion, a third state of being in the standard expansion and floating over a portion of the area of the online portal interface, a fourth state of being in results pane expansion to extend over the area of the online portal interface, and a fifth state of being in post expansion.

11. The user interface according to claim 10, wherein while in the second state and the third state, the assistance panel is configured to receive and surfaces curated help content according to a user role information, a service product information, and a task information for a user accessing the service product through the online portal.

12. The user interface according to claim 10, wherein while in the second state and the third state, the assistance panel is configured to provide a search bar and request help content from a search service using a user search query received via the search bar and a scope query created from the user role information, the service product information and the task information.

13. The user interface according to claim 12, wherein in response to receiving help content results, the assistance panel transforms to the fourth state and is configured to surface the help content results on the results pane.

14. The user interface according to claim 10, wherein in response to receiving a request for community engagement, the assistance panel transforms to the fifth state and is configured to provide a posting interface for a community forum.

15. A computer-readable storage medium comprising instructions that, when executed, cause a system to:
determine context comprising user role information, service product information, and task information for a user accessing a service product through an online portal;
provide an assistance panel within a user interface of the online portal;
provide curated help content within the assistance panel by requesting the curated help content from a community portal using the user role information, the service product information, and the task information, wherein the curated help content is updated as the context changes;
in response to receiving a user search query to the assistance panel, request help content from a search service using the user search query and a scope query created from the user role information, the service product information and the task information; and
in response to receiving a request for community engagement to the assistance panel, provide a portal to a community forum or video chat in the assistance panel.

16. The medium according to claim 15, wherein the curated help content comprises content originating from at least one of a community forum, blog, and wiki, and having a private tag associated therewith.

17. The medium according to claim 15, further comprising instructions that, when executed, cause a system to:
identify one or more keywords from the user search query and passing the one or more keywords to the community portal providing the curated help content; and
update the curated help content on the assistance panel before requesting the help content from the search service.

18. The medium according to claim 15, further comprising instructions that, when executed, cause a system to:
in response to receiving the request for community engagement to the assistance panel, transform the assistance panel to provide a post interface to provide the portal to the community forum; and
post a question received from the post interface in the assistance panel to the community forum.

19. The medium according to claim 15, further comprising instructions that, when executed, cause a system to:
in response to receiving help content results from the search service, transform the assistance panel to extend a search results pane over the user interface of the online portal and surface the help content results.

20. The medium according to claim 15, wherein the task information comprises one or more tags indicating user action, user location on a page of the online portal, or error state.
